(19) United States
(12) Patent Application Publication
(10) Pub. No.: US 2017/0085740 A1
(43) Pub. Date: Mar. 23, 2017

(54) SYSTEMS AND METHODS FOR STORING IMAGES AND SENSOR DATA

(71) Applicant: Invensense, Incorporated, San Jose, CA (US)

(72) Inventors: Shang-Hung Lin, San Jose, CA (US); James Lim, Saratoga, CA (US)

(21) Appl. No.: 14/718,819

(22) Filed: May 21, 2015

(51) Int. Cl. H04N 1/21; H04N 5/232

(52) U.S. Cl. CPC H04N 1/212; H04N 5/2328

(57) ABSTRACT

Systems and methods are disclosed for storing a plurality of images with a portable device. Inertial sensor data from a sensor assembly associated with the portable device may be obtained as each image is captured, allowing determination of a motion of the portable device for each image. Each captured image and the corresponding determined motion of the portable device are stored.

### FIELD OF THE PRESENT DISCLOSURE

This disclosure generally relates to techniques for storing images captured by a mobile device and more specifically to storing sensed motion associated with the captured images to allow subsequent compensation of the captured images using inertial sensor data.

### BACKGROUND

Advances in technology have enabled the introduction of mobile devices that feature an ever increasing set of capabilities. Smartphones, for example, now offer sophisticated computing and sensing resources together with expanded communication functionality. Likewise, tablets, wearables, media players and other similar devices have shared in this progress. Notably, it is desirable and increasingly common to provide a mobile device with digital imaging functions. However, implementations in a mobile device may be particularly susceptible to degradation in quality caused by motion while the video is being recorded. In particular, a camera incorporated into a mobile device is often hand held during use and, despite efforts to be still during image recording, shaking may occur. Since such mobile devices may also be equipped with motion sensing capabilities, techniques exist for using inertial sensor data to improve the quality of images captured using the mobile device to address this issue. For example, video being recorded by the mobile device may be stabilized or otherwise compensated using detected motion.

Despite the advantages associated with these techniques, they may be limited by factors such as the processing capabilities of the mobile device being used to capture the images and the challenges associated with compensating the images as they are recorded. Accordingly, it would be desirable to provide methods and systems for storing both the captured images and the corresponding inertial sensor data to allow for subsequent processing of the captured images using the stored motion information. This disclosure satisfies these and other needs.

### SUMMARY

As will be described in detail below, this disclosure includes a method for storing a plurality of images with a portable device by capturing each image as an output from an image sensor of the portable device, obtaining inertial sensor data from a sensor assembly associated with the portable device as each image is captured, determining a motion of the portable device from the inertial sensor data for each image, storing each captured image and storing the determined motion of the portable device for each captured image.

This disclosure also includes a portable device having an image sensor configured to capture a plurality of images, an inertial sensor outputting inertial sensor data, a sensor processor configured to determine a motion of the portable device from the inertial sensor data for each image and a memory configured to store the plurality of captured images and the determined motion of the portable device for each image.

Further, this disclosure includes a system for storing and processing images including a portable device having an image sensor configured to capture a plurality of images, an inertial sensor outputting inertial sensor data, a sensor processor configured to determine a motion of the portable device from the inertial sensor data for each image and a memory configured to store the plurality of captured images and the determined motion of the portable device for each image and a remote image processor that may receive the stored captured images and the stored determined motions and apply a compensation to each captured image for the determined motion of the portable device when each image was captured to generate a corresponding plurality of stabilized images.

### BRIEF DESCRIPTION OF THE DRAWINGS

FIG. 1 is a schematic diagram of a device configured to store a plurality of captured images according to an embodiment.

FIG. 2 is a schematic diagram illustrating the exchange of signals in an optical image stabilization system according to an embodiment.

FIG. 3 is a schematic diagram illustrating compression of a video stream of a plurality of captured images and a corresponding stabilized video stream compensated by determined motion of the device according to an embodiment.

FIG. 4 is a flowchart showing a routine for storing captured images and corresponding motion information according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration.” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM). FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

As noted above, it is increasingly desirable to provide a mobile electronic device with one or more digital cameras. Correspondingly, it is also desirable to utilize sensor data generated by the mobile device to process images captured by such digital cameras. Notably, a mobile device may employ motion sensors as part of the user interface, such as for determining orientation of the device to adjust the display of information accordingly as well as for receiving user input for controlling an application, for navigational purposes, or for a wide variety of other applications. Data from such a sensor or plurality of sensors may be used to determine motion of the mobile device. By storing the captured images along with corresponding inertial sensor data, any suitable compensation subsequently may be applied to the captured images without being limited by the processing resources available to the mobile device or time constraints associated with recording the images in real time.

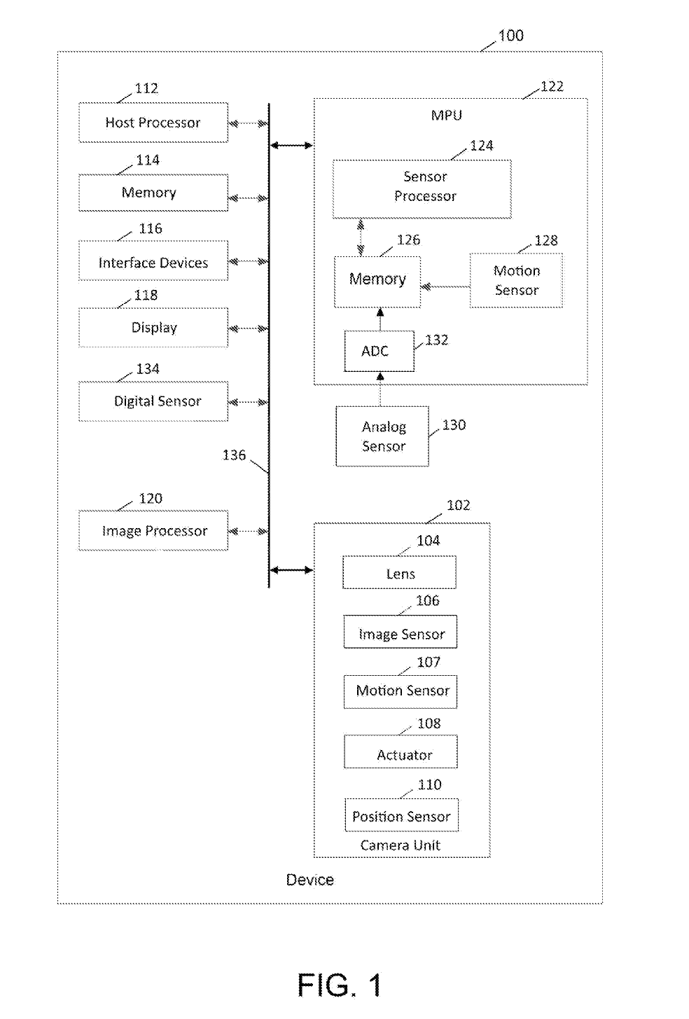

To help illustrate these and other aspects of the disclosure, details regarding one embodiment of a mobile electronic device 100 are depicted as high level schematic blocks in FIG. 1. As will be appreciated, device 100 may be implemented as a device or apparatus, such as a handheld device that can be moved in space by a user and its motion and/or orientation in space therefore sensed. For example, such a handheld device may be a mobile phone (e.g., cellular phone, a phone running on a local network, or any other telephone handset), wired telephone (e.g., a phone attached by a wire), personal digital assistant (PDA), video game player, video game controller, navigation device, activity or fitness tracker device (e.g., bracelet or clip), smart watch, other wearable device, mobile internet device (MID), personal navigation device (PND), digital still camera, digital video camera, binoculars, telephoto lens, portable music, video, or media player, remote control, or other handheld device, or a combination of one or more of these devices.

Device 100 includes a camera unit 102 configured for capturing images. The camera unit 102 includes at least an optical element, such as, for example, a lens 104, which projects the image onto an image sensor 106. The camera unit 102 may optionally be apt to perform optical image stabilization (OIS). Typically, OIS systems include processing to determine compensatory motion of the lens in response to sensed motion of the device or part of the device, such as e.g. the camera (body), actuators to provide the compensatory motion in the image sensor or lens, and position sensors to determine whether the actuators have produced the desired movement. The camera unit 102 may include dedicated motion sensors 107 to determine the motion, or may obtain the motion from another module in the device, such as e.g. the MPU 122. In an embodiment that features OIS, the camera unit includes an actuator 108 for imparting relative movement between lens 104 and image sensor 106 along at least two orthogonal axes. Additionally, a position sensor 110 may be included for determining the position of lens 104 in relation to image sensor 106. Motion sensing may be performed by a general purpose sensor assembly as described below according to techniques disclosed in co-pending, commonly owned U.S. patent application Ser. No. 14/524,807, filed Oct. 27, 2014, which is hereby incorporated by reference in its entirety. In one aspect, actuator 108 may be implemented using voice coil motors (VCM) and position sensor 110 may be implemented with Hall sensors, although other suitable alternatives may be employed.

Device 100 may also include a host processor 112, memory 114, interface device 116 and display 118. Host processor 112 can be one or more microprocessors, central processing units (CPUs), or other processors which run software programs, which may be stored in memory 114, associated with the functions of device 100. Interface devices 116 can be any of a variety of different devices providing input and/or output to a user, such as audio speakers, buttons, touch screen, joystick, slider, knob, printer, scanner, computer network I/O device, other connected peripherals and the like. Display 118 may be configured to output images viewable by the user and may function as a viewfinder for camera unit 102. Further, the embodiment shown features dedicated image processor 120 for receiving output from image sensor 106 as well as controlling the OIS system, although in other embodiments, any distribution of these functionalities may be provided between host processor 112 and other processing resources of device 100. For example, camera unit 102 may include a processor to analyze the motion sensor input and control the actuators. Image processor 120 or other processing resources may also apply stabilization and/or compression algorithms to the captured images as described below.

Accordingly, multiple layers of software can be provided in memory 114, which may be any combination of computer readable medium such as electronic memory or other storage medium such as hard disk, optical disk, etc., for use with the host processor 112. For example, an operating system layer can be provided for device 100 to control and manage system resources in real time, enable functions of application software and other layers, and interface application programs with other software and functions of device 100. Similarly, different software application programs such as menu navigation software, games, camera function control, image processing or adjusting, navigation software, communications software, such as telephony or wireless local area network (WLAN) software, or any of a wide variety of other software and functional interfaces can be provided. In some embodiments, multiple different applications can be provided on a single device 100, and in some of those embodiments, multiple applications can run simultaneously.

Device 100 also includes a general purpose sensor assembly in the form of integrated motion processing unit (MPU™) 122 featuring sensor processor 124, memory 126 and motion sensor 128. Memory 126 may store algorithms, routines or other instructions for processing data output by motion sensor 128 and/or other sensors as described below using logic or controllers of sensor processor 124, as well as storing raw data and/or motion data output by motion sensor 128 or other sensors. Motion sensor 128 may be one or more sensors for measuring motion of device 100 in space. Depending on the configuration, MPU 122 measures one or more axes of rotation and/or one or more axes of acceleration of the device. In one embodiment, at least some of the motion sensors are inertial sensors, such as rotational motion sensors or linear motion sensors. For example, the rotational motion sensors may be gyroscopes to measure angular velocity along one or more orthogonal axes and the linear motion sensors may be accelerometers to measure linear acceleration along one or more orthogonal axes. In one aspect, the gyroscopes and accelerometers may each have 3 orthogonal axes, such as to measure the motion of the device with 6 degrees of freedom. The signals from the sensors may be combined in a sensor fusion operation performed by sensor processor 124 or other processing resources of device 100 provides a six axis determination of motion. The sensor information may be converted, for example, into an orientation, a change of orientation, a speed of motion, or a change in the speed of motion. The information may be deduced for one or more predefined axes, depending on the requirements of the system. As desired, motion sensor 128 may be implemented using MEMS to be integrated with MPU 122 in a single package. Exemplary details regarding suitable configurations of host processor 112 and MPU 122 may be found in co-pending, commonly owned U.S. patent application Ser. No. 11/774,488, filed Jul. 6, 2007, and Ser. No. 12/106,921, filed Apr. 21, 2008, which are hereby incorporated by reference in their entirety. Further, MPU 122 may be configured as a sensor hub by aggregating sensor data from additional processing layers as described in co-pending, commonly owned U.S. patent application Ser. No. 14/480,364, filed Sep. 8, 2014, which is also hereby incorporated by reference in its entirety. Suitable implementations for MPU 122 in device 100 are available from InvenSense, Inc. of San Jose, Calif. Thus, MPU 122 may be configured to provide motion data for purposes independent of camera unit 102, such as to host processor 112 for user interface functions, as well as enabling OIS functionality. Any, or all parts of the MPU may be combined with image processor 120 into a single chip or single package, and may be integrated into the camera unit 102. Any processing or processor needed for the actuator 108 control or position sensor 110 control, may also be included in the same chip or package.

Device 100 may also include other sensors as desired. As shown, analog sensor 130 may provide output to analog to digital converter (ADC) 132, for example within MPU 122. Alternatively or in addition, data output by digital sensor 134 may be communicated over bus 136 to sensor processor 124 or other processing resources in device 100. Analog sensor 130 and digital sensor 134 may provide additional sensor data about the environment surrounding device 100. For example, sensors such as one or more pressure sensors, magnetometers, temperature sensors, infrared sensors, ultrasonic sensors, radio frequency sensors, position sensors such as GPS, or other types of sensors can be provided. In one embodiment, data from a magnetometer measuring along three orthogonal axes may be fused with gyroscope and accelerometer data to provide a nine axis determination of motion. Further, a pressure sensor may be used as an indication of altitude for device 100, such that a sensor fusion operation may provide a ten axis determination of motion.

In the embodiment shown, camera unit 102, MPU 122, host processor 112, memory 114 and other components of device 100 may be coupled through bus 136, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. For example, additional buses may be used to couple the various components of device 100, such as by using a dedicated bus between host processor 112 and memory 114.

As noted above, multiple layers of software may be employed as desired and stored in any combination of memory 114, memory 126, or other suitable location. For example, a motion algorithm layer can provide motion algorithms that provide lower-level processing for raw sensor data provided from the motion sensors and other sensors. A sensor device driver layer may provide a software interface to the hardware sensors of device 100. Further, a suitable application program interface (API) may be provided to facilitate communication between host processor 112 and MPU 122, for example, to transmit desired sensor processing tasks. Other embodiments may feature any desired division of processing between MPU 122 and host processor 112 as appropriate for the applications and/or hardware being employed. For example, lower level software layers may be provided in MPU 122 and an API layer implemented by host processor 112 may allow communication of the states of application programs as well as sensor commands. Some embodiments of API implementations in a motion detecting device are described in co-pending U.S. patent application Ser. No. 12/106,921, incorporated by reference above.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS cap provides mechanical support for the MEMS structure. The MEMS structural layer is attached to the MEMS cap. The MEMS cap is also referred to as handle substrate or handle wafer. In the described embodiments, an MPU may incorporate the sensor. The sensor or sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments the first substrate may be disposed laterally and electrically connected to the second substrate in a single semiconductor package.

As one example, the first substrate may be attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Depending on the context, motion data may refer to processed raw data, which may involve applying a sensor fusion algorithm or applying any other algorithm. In the case of a sensor fusion algorithm, data from one or more sensors may be combined to provide an orientation or orientation change of the device. In the described embodiments, an MPU may include processors, memory, control logic and sensors among structures.

As noted above, a raw video stream comprising a plurality of images captured by camera unit 102 may be shaky due to unintended movements of device 100. A variety of stabilization techniques may be applied to obtain a stabilized video stream. In one aspect, the stabilization technique may involve OIS as described above to generate a compensating relative movement between image sensor 106 and lens 104 in response to detected movement of device 100. In this case the raw video stream captured by the image sensor has been stabilized already due to the motion of the lens. This allows compensation for small movements of the camera and is limited by the displacement limitations of the actuators. In another aspect, the stabilization technique may involve processing operations known in the art as electronic image stabilization (EIS), where the image sensor records the raw video stream without any prior (optical) stabilization. As known in the art, this is an image processing technique where at least two captured images are employed with one serving as a reference. By comparing the second image, it may be determined whether one or more pixels have been translated or “shifted.” To the extent such translation is due to unintended motion of device 100, the second image may be adjusted to generate a stabilized image that minimizes the amount the one or more pixels are shifted, since in the absence of intended movement of the camera and movement of objects in the scene, the pixels should be identical (neglecting camera sensor noise). In yet another aspect, motion of device 100 may be detected by a suitable sensor assembly, such as MPU 122, while an image is being captured. Accordingly, the characteristics of that motion may be used to adjust the captured image by shifting the pixels by an amount that compensates for the detected motion to generate a stabilized image. As desired, one or any combination of these and other techniques may be used to stabilize the raw video stream.

Conventionally, the stabilization algorithm is applied as the images are being captured so that the stabilized video stream is recoded. Although this offers the advantage of being able to review the stabilized video immediately, it may not represent the optimum stabilization available. For example, the camera being used to capture the images, such as device 100, may have processing and/or power constraints that limit the stabilization technique or techniques being applied. As another example, using a more time consuming stabilization technique may result in improved quality as compared to a stabilization technique that is applied as the images are being recorded. Correspondingly, this disclosure involves storing a motion of device 100 determined using a sensor assembly, such as e.g. MPU 122, for each of a plurality of captured images. In turn, any desired stabilization technique may be applied to the captured images at a subsequent time using the determined motion information. For example, the stored captured images and determined motions may be uploaded to a remote image processor, which may have greater processing capabilities than device 100, so that a desired stabilization or other compensation based on the determined motions of device 100 may be applied. As used herein, the term “captured image” refers to the pixels recorded by the image sensor of a digital camera, such as image sensor 106, without further stabilization adjustments. Therefore, to the extent OIS techniques are applied, the captured image may have been stabilized by any compensating changes in the relative positioning of lens 104 and image sensor 106, but no other processing of the recorded pixels has been performed to further stabilize the image.

For the purposes of illustration and without limitation, one suitable technique of this disclosure may be described in the context of storing the determined motion of device 100 as a rotation for each of a plurality of captured images. For example, a three dimensional coordinate system may be established with respect to device 100 having a center (0, 0, 0) such that X₀ is a coordinate vector of a fixed point in the three dimensional space surrounding device 100 that is within the captured image. In other words, X₀ represents an object in the reference frame of the camera. A two dimensional coordinate of the projection of the fixed point corresponding to vector X₀ onto the image plane of image sensor 106 may be expressed as x₀, the image of X₀ on the image sensor, according to Equation (1):

x₀=g(KX₀) (1)

In this equation. K represents the intrinsic camera projection function and g(X) is used to convert the homogeneous coordinates into inhomogeneous coordinates according to Equation (2):

$$g ( X ) = [ \begin{matrix}x / z \\ y / z\end{matrix} ] \qquad ( 2 )$$

Accordingly, at time t, device 100 may have experienced a motion expressed as Rₜ as compared to an initial position of device 100 at t=0. The rotation may be defined using several different notations such as rotation matrices, Euler angles, or quaternions. As a result of the motion of the device, fixed point X₀ will undergo a rotation in the opposite direction of Rₜ in the reference frame of the camera. Thus, the motion represented by Rₜ may be expressed as applying an inverse rotation Rₜ⁻¹ to X₀ resulting in Xₜ, the coordinate vector of the fixed point at time t as indicated by Equation (3):

Xₜ=Rₜ⁻¹X₀ (3)

Thus, a stabilized image may be generated such that the fixed point has a corrected relative coordinate vector Xₜ′ at time t. When all motion of device 100 as represented by rotation Rₜ corresponds to unintended motion, the corrected coordinate vector of the fixed point Xₜ′ should approach or equal X₀, thereby compensating for the motion of device 100. In other words, the corrected Xₜ′ should be identical to X₀ with reference to the reference frame of the device because that means it is projected to the same point on the image sensor and thus unaffected by the unintended motion of the device. From Equation (3), it follows that a Xₜ′ approximately equal to X₀ may be obtained by applying an estimated rotation, \tilde{R}ₜ, to Xₜ as indicated by Equation (4):

Xₜ′=\tilde{R}ₜXₜ≈RₜRₜ⁻¹X₀=X₀ (4)

As will be appreciated, readings from a sensor assembly such as MPU 122, taken at time t, may be used to determine \tilde{R}ₜ. In one aspect, sensor data alone may be employed, but other techniques may be used to refine the estimated rotation as desired. In one embodiment, EIS techniques as described above and/or computer vision techniques such as a random sample consensus (RANSAC) or bundle adjustment algorithms may be used to analyze sequential captured images to improve the rotation estimate. For example, the motion sensor data may be used for a coarse correction, after which EIS techniques may be used for additional final adjustments. These EIS adjustments may then be used to get a more precise estimate of k. Thus, along with each captured image, the techniques of this disclosure include also storing sensor data representing motion of device 100 when each image was captured. The sensor data may be stored as output by motion sensor 128 and/or as processed to any desired degree, such as in the form of estimated rotations \tilde{R}ₜ. Subsequently, the stored sensor data may be used with the captured images to generate one or more compensated images.

In case the motion data and the image data are not obtained at exactly the same time, one of the data may be interpolated or extrapolated to coincide with the other using e.g. time stamping techniques. For example, consider that the motion data is obtained at two different times t₁ and t₂, and that the image data is obtained at t₃ within the time interval [t₁,t₂]. The timestamps of t₁, t₂, and t₃, can be used to interpolated the motion data at times t₁ and t₂ to estimate the exact motion at the time t₃ when the image data is obtained. This increases the precision of the motion estimation and thus can lead to better stabilization results.

In another aspect, the detected motion of device 100 may include an intended motion component as well as the unintended motion component. The rotation Rₜ may include intended motion by the user, for example if the user is panning device 100 to follow an object within the images being captured. However, the rotation Rₜ may also include unintended motion, e.g. shake, jitter or other unwanted perturbations. By characterizing the component of Rₜ that corresponds to this unintended and undesirable motion, a suitable compensation may be applied to the captured image to provide a stabilized image. Accordingly, the rotation Rₜ may be expressed using the intended rotation R_{IM,t} and the unintended motion Ru_{UM,t} according to Equation (5):

Rₜ=R_{IM,t}R_{UM,t} (5)

Similarly, Equation (3) may be rewritten to reflect both motion components, as indicated by Equation (6):

Xₜ=Rₜ⁻¹X₀=(R_{IM,t}⁻¹R_{UM,t}⁻¹)X₀ (6)

In this context, however, it may be desirable to compensate only for the unintended motion component, similar to Equation (4), by applying a corresponding estimated rotation \tilde{R}_{UM,t} due to the unintended motion as shown in Equation (7):

Xₜ′=\tilde{R}_{UM,t}Xₜ≈R_{UM,t}(R_{UM,t}⁻¹R_{IM,t}⁻¹)X₀=R_{IM,t}⁻¹X₀ (7)

As shown, the corrected Xₜ′ in this example reflects a change in position only from X₀ that corresponds to the intended rotation R_{IM,t}. In most applications this is what is desirable, removing the unintended motion, while keeping the intended motion.

Following the discussion above, inertial sensor data, such as e.g. from MPU 122, may be used to determine estimated rotation \tilde{R}ₜ which by extension includes estimated intended motion in the form of \tilde{R}_{IM,t} and estimated unintended rotation in the form of \tilde{R}_{UM,t}. Since intended motion usually typically consists of a smooth panning action or other similar movement, the \tilde{R}_{IM,t} component may be characterized by performing a suitable filtering operation, for example low pass filtering. Similarly, unintended motion primarily may result from shaking or vibration of device 100 having a relatively high frequency. As such, the \tilde{R}_{UM,t} component also may be characterized using a filtering operation, such as high pass filtering. The low and high pass filtering may be applied to the raw sensor data, or may applied after processing the sensor data, such as after the determination of the rotation \tilde{R}ₜ. The filtering parameters, such as e.g. the cut off frequencies, may be adaptive. For example, the parameters may adapt to the user, or may be optimized to get the best image stabilization results. Alternatively, or in addition, the respective components may be determined in other suitable manners, including the application of techniques discussed above such as EIS or other computer vision algorithms. Accordingly, in one aspect, one or more image processing techniques may be combined with motion sensor information to characterize the \tilde{R}_{UM,t} component as discussed above. The combination of the computer vision techniques with the motion data may also be used to determine the cut-off frequencies or other parameters. This can be done as a learning stage, e.g. in order to optimize the parameters to the user, after which the motion data may be used without the computer vision techniques.

In another aspect, device 100 may have OIS capabilities as described above. Notably, an OIS operation may involve a change in relation between lens 104 and image sensor 106 to compensate for motion of device 100 that affects the projection on the image sensor. Correspondingly, the rotation matrix Rₜ may also include an OIS component in addition to the intended and unintended components described above, such that the total rotation Rₜ may be expressed as Equation (8):

Rₜ=R_{IM,t}R_{UM,t}R_{OIS,t} (8)

Since the OIS system is configured to compensate for unintended motion of device 100 as the plurality of images are being captured, an ideal system would result in an OIS rotation that is the inverse of the unintended motion rotation according to Equation (9):

R_{OIS,t}=R_{UM,t}⁻¹ (9)

By combining Equation (8) and (9), it shows that in a perfectly functioning OIS system only the intended motion remains. However, OIS may not be able to completely compensate the unintended movement for various reasons, such as a limited range of motion for actuator 108 that may render it unable to cancel out motion beyond a certain threshold. Other factors may also result in an OIS rotation that may not be equivalent to the inverse unintended motion rotation component, R⁻¹_{UM,t}. Correspondingly, the motion sensor information may be considered to include a residual rotation component that represents the unintended motion that was not compensated by the OIS system, R_{RES,t}. As discussed above, any suitable technique may be employed to determine the estimated unintended rotation component \tilde{R}_{UM,t}. Further, the OIS rotation component R_{OIS,t} may be estimated as \tilde{R}_{OIS,t} using any suitable technique. For example, positive feedback may be provided by the OIS system from position sensor 110. Alternatively, or in addition, the estimated \tilde{R}_{OIS,t} may be inferred from control signals sent to actuator 108 by assuming that the OIS system was driven correctly. In addition and/or in the alternative, sync signals may be available during the row and frame readout of the sensors to help determine the relative positioning of lens 104 and image sensor 106 at the different stages of image recording.

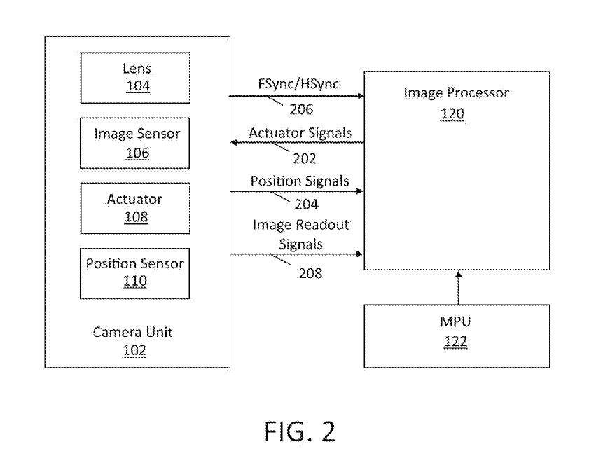

An example of such a system is shown in FIG. 2, which schematically depicts the exchange of signals between image processor 120 and camera unit 102. In one aspect, image processor 120 may receive inertial sensor data representing movement of device 100, such as from MPU 122 as shown. In other architectures, any suitable source of inertial sensor data may be employed, including a dedicated OIS motion sensor assembly. Image processor 120 may employ the inertial sensor data to determine an appropriate change in relative position between lens 104 and image sensor 106 to compensate for the detected movement. As such, image processor 120 sends actuator signals 202 configured to cause actuator 108 to produce the desired relative change in position. In this embodiment, position sensor 110 produces an output position signal 204 reflecting the relationship between lens 104 and image sensor 106 as feedback to verify that operation of actuator 108 has resulted in the desired change in relative position. Further, the HSync and FSync signals 206 correspond to row and frame information from image sensor 106, respectively. The image readout signals 208 transfer the data from the image sensor 106 to the image processor 120. Any one or combination of signals 202, 204, 206 and 208 may be used to estimate \tilde{R}_{OIS,t}.

Correspondingly, the estimations \tilde{R}_{OIS,t} and \tilde{R}_{UM,t} may be used to determine the residual as \tilde{R}_{RES,t} according to Equation (10):

\tilde{R}_{RES,t}=\tilde{R}_{UM,t}\tilde{R}_{OIS,t} (10)

By combining Equation (9) and (10), it shows that if \tilde{R}_{OIS,t} is the inverse of \tilde{R}_{UM,t} the residual rotation \tilde{R}_{RES,t} is a unitary rotation which does not alter Xₜ. Since the OIS is designed to remove unintended motion, and does not have the amplitude to compensate intended motions, like e.g. panning, the effective total rotation Rₜ may be expressed as Equation (11):

Rₜ=R_{IM,t}R_{RES,t} (11)

Because Equation (11) is similar to Equation (5), and considering that R_{RES,t} represents the remaining unintended motion R_{UM,t}, Equation (11) may be applied in a similar manner as discussed above in relation to Equation (5).

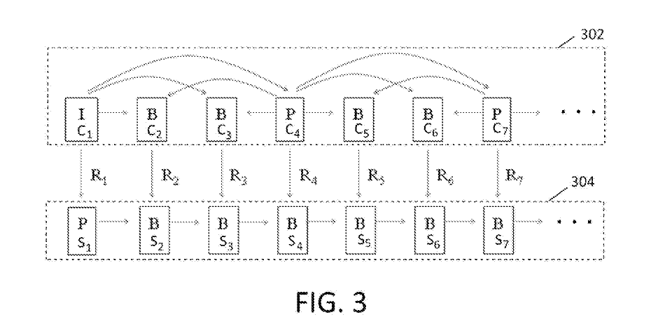

As discussed above, device 100 may store a plurality of captured images as well as corresponding inertial sensor data for each image. In some embodiments, the plurality of captured images may be stored using a suitable compression algorithm One example of a compressed video stream is shown in FIG. 3 and may include several types of frames, including intra-frames (I), forward predicted frames (P), and bidirectionally predicted frames (B). As shown, a video stream may be represented by a sequence 302 of captured images Cᵢ, for i=1 to t. In one example, sequence 302 may correspond to the raw video stream. According to the compression algorithm used for the exemplary embodiment, an initial captured image C₁ is stored so that it may be reconstructed without reference to any other frames (C₁ is an I-frame). Succeeding captured images C₂, C₃ . . . are inter coded and are reconstructed from either preceding images for the forward predicted P frames or from preceding and succeeding frames for the bidirectionally predicted B frames. This compression strategy is known to the person skilled in the art of video compression, and is presented as an illustration only and other compression algorithms may be used without limitation.

Further, inertial sensor data corresponding to each captured image Cᵢ may also be recorded in any suitable manner. For example, the inertial sensor data may be recorded in a separate file with an appropriate indexing scheme to associate the corresponding data with the captured images. As another example, the inertial sensor data may be integrated with captured images, such as by storing the data in a header of each captured image. The motion data and the image data may both include time stamp data in order to align both data if they were not taken at the same time. In the embodiment shown, the inertial sensor data may be stored as rotations Rᵢ as described above, but other techniques for storing the inertial sensor data may be used as desired, including other rotations, translations or the like in the form of quaternions, rotation matrices, Euler angles, or other expressions of motion. The motion data may even be stored as raw motion sensor signals. This allows for a maximum flexibility on how to process the motion data, but may take more processing time and power. As shown in FIG. 3, using a first stabilization algorithm, a stabilized image Sᵢ may be generated for each captured image Cᵢ by applying the corresponding rotation Rᵢ in order to output stabilized video stream 304. Depending on the embodiment, rotations Rᵢ may be calculated from inertial sensor data output by MPU 122, or another suitable sensor assembly or combination with video processing techniques, contemporaneously as the images are being captured or in a subsequent post-processing operation.

In alternative embodiment, the motion data for each captured image is stored as discussed above, but is not used in the first stabilization algorithm. The first stabilization algorithm may use other techniques, such as e.g. EIS, to compute the stabilized image stream 304.

In one aspect, a stabilized video stream generated by applying a first stabilization algorithm may be recorded in addition to the plurality of captured images. Such implementations offer considerable flexibility in that a user may elect to play the stabilized video stream immediately or may utilize the recorded inertial sensor data to apply a second stabilization algorithm at a later stage. The second stabilization algorithm may be configured to exploit a greater amount of processing time, enhanced processing resources that may not be available in device 100, or both. In general, the first stabilization algorithm may be applied as the sequence of images are being captured while the second stabilization algorithm, having access to the stored inertial sensor data, may be applied after the sequence of images have been captured. In one example, the second stabilization algorithm is also performed in the device, but this second algorithm may take too much time to record the stabilized stream in real time. Therefore, a first, faster, stabilization algorithm is used to record the stabilized stream in real time, and the second, slower but better, algorithm is run off-line. The stabilized images from the second algorithm may replace the stabilized images from the first algorithm once the images are ready. In another embodiment, the second stabilization algorithm may be performed in a second device, providing that the second device has access to the captured images and the motion data. The access may be provided by allowing the device access to the data stored on the first device, or the data may be transferred to the second device. The stabilized image stream from the second stabilization algorithm may be stored on the second device, but may also replace the stabilized video stream from the first algorithm on the first device.

Recording a video stream stabilized using the first algorithm in addition to storing the raw video stream may represent a relatively small increase in memory requirements. The residue after the stabilization corresponds primarily to objects moving in the scene or new objects entering the scene due to panning, while the background remains relatively unchanged. In addition, the residue contains the residual errors if the stabilization has not been perfect. The associated motion vectors employed by the compression algorithm to reconstruct the inter-coded frames are therefore small and may be compressed easily.

FIG. 3 shows an embodiment where the motion data is being stored for each captured frame. In an alternative embodiment, the synchronization signals as discussed in relation to FIG. 2 may be used to store the motion data with a higher time resolution. For example, the motion data may be stored at each Hsync signal, representing the read out of a row of pixels of the image sensor. This provides the possibility for an improved motion correction algorithm since the details of the motion will be recorded during the different read out stages of the image sensor. For example, the rotation discussed above may have two dimensions, where a first dimension refers to the frame number, and a second dimension refers to the Hsync within that frame.

In some embodiments, the motion data and the Hsync/Fsync signals may be attributed timestamp from a system clock. The timestamp may be used to determine the exact time of the motion data compared to the image data. If required, for example if the motion is the device is varying a lot, the motion data may be interpolated to determine the exact motion at the time of the image capture.

Although a number of the embodiments have been described in the context of a plurality of captured images that constitute a video stream, the techniques of this disclosure may also be applied to generating a composite still image from a plurality of captured images. As will be appreciated, such a composite image may be a stitched together panoramic image that represents a greater field of view than any one of the captured images, an increased resolution image in which additional pixels are interpolated or extrapolated from multiple captured images, or an image that is otherwise enhanced (e.g., to compensate for low light, to improve color accuracy or other similar adjustments) using multiple captured images. The general idea is that any motion or other sensor data that is relevant or can be used to improve the final image is stored with the raw image. A first algorithm may be performed in real time, and a second e.g. more complex algorithm may be performed at a later time using the stored sensor data.

In some embodiments, the intrinsic camera projection function K may need to be known to perform the stabilization. The intrinsic camera parameters may be supplied by the manufacturer of the lens system, and may be stored in one of the devices memory. If the stabilization using the motion data is used in a second device, this device should have access to the intrinsic camera parameters. The parameters may also be included with the captures images, similar to the motion data. In case the intrinsic parameters change during the recording of the video stream, for example by changing the optical zoom, the changed parameters have to be included on a frame-by-frame basis, or with the frame when changes take place. Some of the required parameters may also be learned by comparing the motion data to other techniques such as EIS, for example by determining the influence of the motion on the objects in the image parameters of the projection function may be determined.

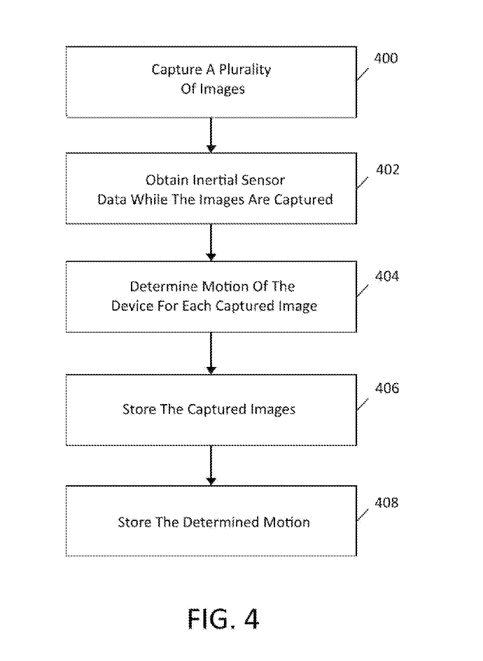

To help illustrate aspects of this disclosure, an exemplary routine for storing a plurality of captured images using device 100 is represented by the flowchart shown in FIG. 4. Beginning with 400, each of a plurality of images may be captured by device 100 using image sensor 106. Inertial sensor data is obtained from a suitable sensor assembly, such as motion sensor 128 in 402. From the inertial sensor data, motion or another movement characteristic for device 100 corresponding to each captured image may be determined in 404. Then, in 406 each captured image is stored and in 408 the corresponding determined motion is stored. The plurality of captured images and the associated inertial sensor data may be stored or recorded in any suitable component of device 100, such as memory 114.

In one aspect, a first compensation may be applied to each captured image for the determined motion of the portable device corresponding to each image so that a corresponding plurality of stabilized images may be generated and stored. The first compensation may occur at a first time, such as while the plurality of images are being captured. Further, the plurality of captured images and the determined motion of the portable device when each image was captured may be retrieved so that a second compensation may be applied to each captured image to generate a corresponding plurality of stabilized images. The second compensation may occur at a second time, after the first time, such as after the plurality of images are captured.

In one aspect, the determined motion of the portable device for each captured image may include unintended motion. Further, the determined motion of the portable device for each captured image may also include intended motion, such that an intended motion portion and an unintended motion portion of the determined motion may be identified. Identifying the intended motion portion and the unintended motion portion may include performing a filtering operation. For example, the intended motion portion may be identified by performing a low pass filter operation. As another example, the unintended motion portion may be identified by performing a high pass filter operation. Alternatively, or in addition, the unintended motion portion may be identified by processing at least some of the plurality of captured images, such as by assessing pixel translation.

In one aspect, the motion of the portable device may be determined from the inertial sensor data using information from processing at least some of the plurality of captured images and the augmented determined motion may be stored.

In one aspect, optical image stabilization may be performed as each image is captured and stabilization motion information regarding displacement of a lens relative to the image sensor for each captured image may be stored. Further, row and frame signals from the image sensor may be used when determining the motion of the portable device.

In one aspect, storing each captured image may include applying a compression algorithm to generate a video stream. The determined motion of the portable device for each captured image may be stored in the video stream or may be stored by indexing the stored determined motion to each of the plurality of captured images.

In one aspect, the stored compressed plurality of captured images may be decompressed and a compensation using the stored determined motion of the portable device may be applied for each captured image.

In one aspect, storing the determined motion of the portable device for each captured image may include storing the determined motion in relation to compressed captured images.

In one aspect, the plurality of captured images may be combined into a single image.

As noted above, this disclosure may also include a portable device. In one aspect, the device may include a stabilization processor to apply a first compensation using the determined motion of the portable device when each image was captured as the plurality of images are captured. Further, the stabilization processor may also apply a second compensation to the plurality of images using the determined motion of the portable device when each image was captured after the images are captured.

In one aspect, the device may include an optical image stabilization system including an actuator configured to adjust a relative positioning of a lens and the image sensor for each captured image, wherein the memory is configured to store motion indicated by the optical image stabilization system.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A method for storing a plurality of images with a portable device, the method comprising:
capturing each image as an output from an image sensor of the portable device;
obtaining inertial sensor data from a sensor assembly associated with the portable device as each image is captured;
determining a motion of the portable device from the inertial sensor data for each image;
storing each captured image; and
storing the determined motion of the portable device for each captured image.

2. The method of claim 1, further comprising applying a first compensation to each captured image for the determined motion of the portable device corresponding to each image to generate a corresponding plurality of stabilized images and storing each stabilized image.

3. The method of claim 2, wherein applying the first compensation occurs at a first time.

4. The method of claim 3, further comprising retrieving the plurality of captured images, retrieving the determined motion of the portable device when each image was captured and applying a second compensation to each captured image for the determined motion of the portable device when each image was captured to generate a corresponding plurality of stabilized images.

5. The method of claim 4, wherein applying the second compensation occurs at a second time, wherein the second time occurs after the first time.

6. The method of claim 1, wherein the determined motion of the portable device for each captured image comprises unintended motion.

7. The method of claim 6, wherein the determined motion of the portable device for each captured image further comprises intended motion, further comprising identifying an intended motion portion and an unintended motion portion of the determined motion

8. The method of claim 7, wherein identifying the intended motion portion and the unintended motion portion comprises performing a filtering operation.

9. The method of claim 8, wherein the intended motion portion is identified by performing a low pass filter operation.

10. The method of claim 8, wherein the unintended motion portion is identified by performing a high pass filter operation.

11. The method of claim 7, wherein the unintended motion portion is identified by processing at least some of the plurality of captured images.

12. The method of claim 11, wherein processing at least some of the plurality of captured images comprises assessing pixel translation.

13. The method of claim 11, further comprising augmenting the determined motion of the portable device from the inertial sensor data with information from the processing of at least some of the plurality of captured images such that storing the determined motion of the portable device for each captured image comprises storing the augmented determined motion.

14. The method of claim 1, further comprising processing of at least some of the plurality of captured images and augmenting the determined motion of the portable device from the inertial sensor data with information from the processing of at least some of the plurality of captured images such that storing the determined motion of the portable device for each captured image comprises storing the augmented determined motion.

15. The method of claim 1, further comprising:
performing optical image stabilization as each image is captured;
outputting motion information regarding displacement of a lens relative to the image sensor for each captured image; and
storing motion indicated by the motion information.

16. The method of claim 1, wherein storing each captured image comprises applying a compression algorithm to generate a video stream.

17. The method of claim 16, wherein the determined motion of the portable device for each captured image is stored in the video stream.

18. The method of claim 1, wherein storing the determined motion of the portable device for each captured image comprises indexing the stored determined motion to each of the plurality of captured images.

19. The method of claim 16, further comprising decompressing the stored plurality of captured images and applying a compensation using the stored determined motion of the portable device for each captured image.

20. The method of claim 19, wherein storing the determined motion of the portable device for each captured image comprises storing the determined motion in relation to the compressed captured images.

21. The method of claim 1, wherein the plurality of captured images are combined into a single image.

22. The method of claim 1, further comprising uploading the stored captured images and the stored determined motions to a remote image processor and applying a compensation to each captured image for the determined motion of the portable device when each image was captured to generate a corresponding plurality of stabilized images with the remote image processor.

23. A portable device comprising:
an image sensor configured to capture a plurality of images;
an inertial sensor outputting inertial sensor data;
a sensor processor configured to determine a motion of the portable device from the inertial sensor data for each image; and
a memory configured to store the plurality of captured images and the determined motion of the portable device for each image.

24. The portable device of claim 23, further comprising a stabilization processor configured to apply a first compensation using the determined motion of the portable device when each image was captured as the plurality of images are captured.

25. The portable device of claim 24, wherein the stabilization processor is further configured to apply a second compensation to the plurality of images using the determined motion of the portable device when each image was captured after the images are captured.

26. The portable device of claim 23, further comprising an optical image stabilization system including an actuator configured to adjust a relative positioning of a lens and the image sensor for each captured image, wherein the memory is configured to store motion indicated by the optical image stabilization system.

27. The portable device of claim 26, wherein the sensor processor is further configured to use row and frame signals from the image sensor in determining the motion of the portable device.

28. A system for storing a plurality of captured images, comprising:
a portable device comprising:
an image sensor configured to capture a plurality of images;
an inertial sensor outputting inertial sensor data;
a sensor processor configured to determine a motion of the portable device from the inertial sensor data for each image; and
a memory configured to store the plurality of captured images and the determined motion of the portable device for each image; and
a remote image processor configured to:
receive the stored captured images and the stored determined motions from the portable device; and
apply a compensation to each captured image for the determined motion of the portable device when each image was captured to generate a corresponding plurality of stabilized images.
